(19) United States
(12) Patent Application Publication
(10) Pub. No.: US 2013/0247731 A1
(43) Pub. Date: Sep. 26, 2013

(54) MEDICING CUTTING DEVICE AND AUTOMATIC MEDICINE PACKING MACHINE WITH THE SAME

(71) Applicant: JVM CO., LTD., Daegu (KR)

(72) Inventor: Jun Ho Kim, Daegu (KR)

(21) Appl. No.: 13/850,018

(22) Filed: Mar. 25, 2013

(30) Foreign Application Priority Data
Mar. 26, 2012 (KR) 10-2012-0030422
Mar. 19, 2013 (KR) 10-2013-0029309

(51) Int. Cl. B26D 7/06; B26D 7/32; B26D 7/01

(52) U.S. Cl. CPC B26D 7/06; B26D 7/01; B26D 7/32
USPC 83/109; 83/613; 83/467.1; 83/79; 83/418

(57) ABSTRACT

Provided is a medicine cutting device capable of cutting an accommodated medicine into halves and discharging the cut medicines. A medicine cutting device for cutting and discharging medicines while moving one pill at a time includes: a first member disposed in parallel to a direction in which a medicine is supplied; and a second member facing the first member, wherein the medicine is disposed between the first member and the second member. The medicine is cut while the second member reciprocates with respect to the fixed first member, or the first member reciprocates with respect to the fixed second member, or the first member and the second member simultaneously reciprocate in a mutually proximal or distal direction.

### CROSS-REFERENCE(S) TO RELATED APPLICATION

This application claims priority of Korean Patent Application Nos. 10-2012-0030422, filed on Mar. 26, 2012, and 10-2013-0029309, filed on Mar. 19, 2013, in the Korean Intellectual Property Office, each of which is incorporated herein by reference in its entirety.

### BACKGROUND

1. Technical Field

The present disclosure relates to a medicine cutting device and an automatic medicine packing machine with the same, and more particularly, a medicine cutting device, capable of cutting an accommodated medicine into halves and discharging the cut medicines, and an automatic medicine packing machine with the same.

2. Description of the Related Art

Conventionally, an automatic medicine packing machine receives medicines, such as tablets or capsules, from a plurality of cassettes, in which the medicines classified by their kinds are respectively accommodated, and consecutively packs the medicines into doses.

The conventional automatic medicine packing machine includes a plurality of cassettes, a hopper, a printing unit, and a packing unit. The plurality of cassettes are disposed in an upper portion of a main body of the automatic medicine packing machine and accommodate medicines such as tablets or capsules having various sizes and shapes. The hopper is disposed in a lower portion of the main body and collects the medicines discharged and dropped from the cassettes. The printing unit prints a variety of information on a packing paper for packing the medicines. The packing unit packs the medicines with the packing paper when the medicines are collected in the hopper.

In the conventional automatic medicine packing machine, each of the cassettes includes a cassette body, a distribution block, a cassette support, and a partition member. The cassette body accommodates the medicines such as tablets or capsules having various sizes and shapes. The distribution block is rotatably provided in the cassette body to separate and discharge the medicines. The cassette support supports the cassette body and has a motor embedded therein to rotate the distribution block. The partition member is installed in the cassette body to discharge the medicines in a predetermined amount when the medicines are discharged by the distribution block.

The distribution block includes a plurality of discharge grooves in an outer peripheral surface thereof, so that the medicines accommodated in the cassette body are discharged along the discharge grooves to the outside of the cassette body. In this case, the partition member blocks the discharge grooves so that a predetermined amount of the medicine is discharged.

Various examples of the cassettes are disclosed in Patent Document 1 (Japanese Patent Application Laid-Open No. H9-266940) and Patent Document 2 (U.S. Pat. No. 5,803,309). These conventional cassettes discharge only the medicines having the same size and shapes, such as a circular or elliptical shape.

However, in some cases, a physician or a pharmacist may prescribe a half-cut-tablet made by cutting a tablet into halves. From the same viewpoint, as disclosed in Patent Document 3 (Korean Utility Model Registration No. 20-0237932), a device for cutting a tablet by a user's grip has been developed. However, in such a device, a user needs to perform a work while holding a tablet during a tablet cutting process. Thus, it is not preferable for sanitary reasons because the medicine may be contaminated. Also, it is not easy to cut the medicine into two exact halves. Therefore, Applicants believe there is a need for a cutting device capable of cutting medicines into two exact halves.

### BRIEF SUMMARY

Embodiments of the present invention are directed to provide a medicine cutting device, capable of cutting and discharging medicines while automatically moving one pill at a time, and an automatic medicine packing machine with the same.

According to an embodiment of the present invention, a medicine cutting device for cutting and discharging medicines while moving one pill at a time includes: a first member disposed in parallel to a direction in which a medicine is supplied; and a second member facing the first member, wherein the medicine is disposed between the first member and the second member, wherein the medicine is cut while the second member reciprocates with respect to the fixed first member, or the first member reciprocates with respect to the fixed second member, or the first member and the second member simultaneously reciprocate in a mutually proximal or distal direction.

The first member may be a first cutter in which a first cutter blade of an upper end thereof is disposed in parallel to a direction in which the medicine is supplied, and faces the second member.

The second member may be a second cutter in which a second cutter blade of a lower end thereof is disposed in parallel to a direction in which the medicine is supplied, and faces the first member, or may be a pressing block that faces the first member, moves upward from an upper portion of the first member, and applies a pressure to the medicine when the medicine is disposed between the first member and the second member.

The pressing block may be made of an elastic material that closely contacts the medicine according to an outer-surface shape of the medicine.

The medicine cutting device may further include spring plates that are disposed on both sides of the first member, are perpendicular to the first member, provide an area where the medicine is disposed, and allow a shape deformation, wherein top surfaces of the spring plates are higher than or equal to top end of the first member.

The medicine cutting device may further include a guide member for supporting both sides of the first member, wherein the guide member is a fixing jig with a fixing slit for closely supporting and fixing a lower portion of the first member.

The medicine cutting device may further include a guide member for supporting both sides of the first member, wherein the guide member is a guide block that is disposed in close contact with both surfaces of the first member, moves upward while interworking with the second member, and, when a pressure by the second member is applied to the medicine, moves downward while interworking with the second member, until the medicine is cut into halves. The medicine may be held on an upper end of the first member and a top surface of the guide block.

An end edge of the first cutter blade and a top surface of the guide block may be disposed on the same plane.

The medicine cutting device may further include a guide groove recessed on both sides with reference to an upper portion of the first member on the top surface of the guide block.

A bottom surface of the guide groove may be disposed on the same plane as the top surface of the first member.

According to another aspect of the present invention, the first member may be an inclined plate installed in an inclined manner, and the second member may be a cutter. The medicine cutting device may further include a stopping plate for stopping the medicine which is moving on the inclined plate. The cutter may cut the medicine stopped by the stopping plate into halves.

The medicine cutting device may further include: holding members for holding the medicine, which is stopped by the stopping plate, from left and right, such that the medicine is cut by the cutter.

The holding member may be moved left and right by a torque transmission unit including a rack gear and a pinion driven by a motor.

The torque transmission unit may further include a clutch disposed between the motor and the pinion.

The pair of left and right holding members may be movable in opposite directions on the inclined plate. Surfaces of the holding members, which directly come into contact with the medicine, may be made of an elastic material so as to prevent the medicine from being damaged.

The medicine cutting device may further include a distance sensor for measuring a distance between the holding members when holding the medicine from left and right.

The medicine cutting device may further include a controller for discharging the medicine, without cutting the medicine, when a distance between the holding members, which is detected by the distance sensor in an n-th cutting operation, is different from a distance between the holding members, which is detected by the distance sensor in an (n-1)-th cutting operation in a consecutive cutting process.

The stopping plate may be installed to be movable in a direction perpendicular to the inclined plate, such that the stopping plate moves downward when the cutting operation of the cutter is completed, and supplies half-cut-medicines to an accommodation container.

The cutter may move in a direction perpendicular to the inclined plate, maintain a predetermined spacing from the inclined plate in a standby mode, and be movable toward the inclined plate by a cam member when the medicine is held by the holding members.

The medicine cutting device may further include a transferring unit for transferring half-cut-medicines, which are cut into halves by the cutter, toward an accommodation container.

The transferring unit may include: a transfer passage; and a pivot member pivotally installed inside the transfer passage.

The transferring unit may further include: the accommodation container for accommodating the half-cut-medicines; and a collection container for accommodating uncut medicines.

The medicine cutting device may further include an aligning unit mounted on the frame to align the moving medicines in a row such that the medicines are spaced apart from one another.

The aligning unit may include: a vibrator for generating vibration; a plate attached to the vibrator to vibrate together with the vibrator; and a groove section formed in the plate so as to move the medicines in a row.

The aligning unit may further include a detection passage mounted with a sensor so as to detect the number of medicines supplied to the cutter.

An upper surface of the plate may be coated with one or more of a Teflon resin and a urethane resin.

The medicine cutting device may further include a supplying unit disposed in an upstream side of the cutter to supply a medicine to be cut to the cutter.

The supplying unit may be a cylindrical feeder which moves medicines along a spiral path by vibration.

The supplying unit may be a cassette which is detachably mounted to discharge medicines accommodated therein one pill at a time.

The medicine cutting device may further include a cassette support installed to support the cassette, such that the cassette is disposed above the cutter.

The medicine cutting device may further include a detection passage for detecting the number of medicines discharged from the cassette and supplied to the cutter.

The medicine cutting device may further include a transverse laying-down unit for laying an upright medicine down sideways such that an elongated side of the medicine comes into contact with the stopping plate.

The transverse laying-down unit may include: a transverse laying-down member for sliding in a transverse direction so as to apply an external force to the stopped medicine in a transverse direction; and a motor for providing torque so as to move the transverse laying-down member.

The medicine cutting device may further include a longitudinal laying-down unit for laying down the medicine, which is stopped upright by the stopping plate, on the inclined plate.

The longitudinal laying-down unit may include: a longitudinal laying-down member pivotally installed to apply an external force to the medicine stopped by the stopping plate; and an elastic member for applying pressure to pivot the longitudinal laying-down member.

The longitudinal laying-down unit may be installed to be pivotable around a shaft within a concave section formed in the stopping plate, and the elastic member may be a coil spring inserted into the shaft.

The medicine cutting device may further include a forcible transferring unit for forcibly transferring the medicines cut by the cutter, such that the cut medicines are transferred along the inclined plate.

The forcible transferring unit may include: a forcible transferring member installed to perform a reciprocating pivoting motion on the inclined plate; a flexible section attached to a distal end of the forcible transferring member; and a motor for pivoting the forcible transferring member around a rotational shaft.

According to another embodiment of the present invention, an automatic medicine packing machine for consecutively packing various kinds of medicines into doses according to prescriptions includes: a plurality of cassettes arranged in an upper portion of a main body of the automatic medicine packing machine and accommodating medicines having various sizes and shapes; and a medicine cutting device for cutting and discharging medicines while moving one pill at a time.

### BRIEF DESCRIPTION OF THE SEVERAL VIEWS OF THE DRAWINGS

FIG. 1 is a perspective view of a medicine cutting device according to a first embodiment of the present invention.

FIG. 2 is a side view of main parts in the medicine cutting device according to the first embodiment of the present invention.

FIG. 3 is a plan view of main parts in the medicine cutting device according to the first embodiment of the present invention.

FIGS. 4A and 4B are diagrams for describing an operation of holding members for holding a medicine in the medicine cutting device according to the first embodiment of the present invention.

FIGS. 5A and 5B are diagrams for describing an operation of a cutter for cutting a medicine in the medicine cutting device according to the first embodiment of the present invention.

FIGS. 6A and 6B are diagrams for describing an operation of a transverse laying-down unit for vibrating a medicine in a transverse direction, such that the medicine is laid down in a transverse direction, in the medicine cutting device according to the first embodiment of the present invention.

FIGS. 7A and 7B are diagrams for describing an operation of a longitudinal laying-down unit for vibrating a medicine in a longitudinal direction, such that the medicine is laid down in a longitudinal direction, in the medicine cutting device according to the first embodiment of the present invention.

FIGS. 8A and 8B are diagrams for describing an operation of a forcible transferring unit for forcibly transferring a cut medicine in the medicine cutting device according to the first embodiment of the present invention.

FIG. 9 is a perspective view of a medicine cutting device according to a second embodiment of the present invention.

FIG. 10 is a plan view of main parts in the medicine cutting device according to the second embodiment of the present invention.

FIG. 11 is a plan view of main parts in the medicine cutting device according to the second embodiment of the present invention.

FIG. 12 is a schematic perspective view illustrating a stat in which the medicine cutting device according to the embodiment of the present invention is mounted on an automatic medicine packing machine.

FIG. 13 is a schematic front view illustrating a stat in which the medicine cutting device according to the embodiment of the present invention is mounted on the automatic medicine packing machine.

FIG. 14 is a conceptual diagram illustrating an overall configuration of a medicine cutting device according to a third embodiment of the present invention.

FIG. 15 is a conceptual diagram illustrating a state in which the medicine cutting device according to the third embodiment of the present invention cuts a medicine.

FIG. 16 is a conceptual diagram illustrating an overall configuration of a medicine cutting device according to a fourth embodiment of the present invention.

FIG. 17 is a conceptual diagram illustrating a state in which the medicine cutting device according to the fourth embodiment of the present invention cuts a medicine.

FIG. 18 is a conceptual diagram illustrating an overall configuration of a medicine cutting device according to a modification of the fourth embodiment of the present invention.

FIG. 19 is a side conceptual diagram, when viewed from point A of FIG. 16, illustrating a state in which the medicine cutting device according to the fourth embodiment of the present invention is installed.

### DETAILED DESCRIPTION

Hereinafter, medicine cutting devices according to example embodiments of the present invention will be described in detail with reference to the accompanying drawings.

In the present disclosure, the term “medicine” denotes tablets that have various shapes, for example, a circular or elliptical shape, and can be prescribed in the form of a half-cut-tablet made by cutting the medicine into halves. Also, it should be understood that the medicine includes both a coated tablet and an uncoated tablet.

The medicine cutting device according to embodiments of the present invention refers to a device capable of accurately aligning medicines on a dose basis, holding and cutting the medicines while moving one pill at a time, and individually discharging the cut medicines. To realize the accurate individual discharge of medicine, it is necessary to align a pile of medicines such that the respective medicines are spaced apart from one another by a predetermined distance. If the respective medicines are arranged excessively close to one another, there is a risk of discharging one or more medicines simultaneously by inertia.

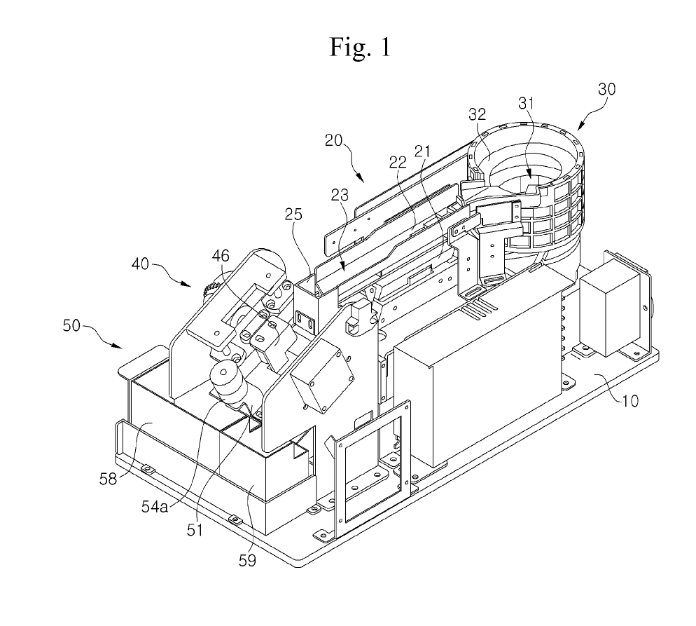

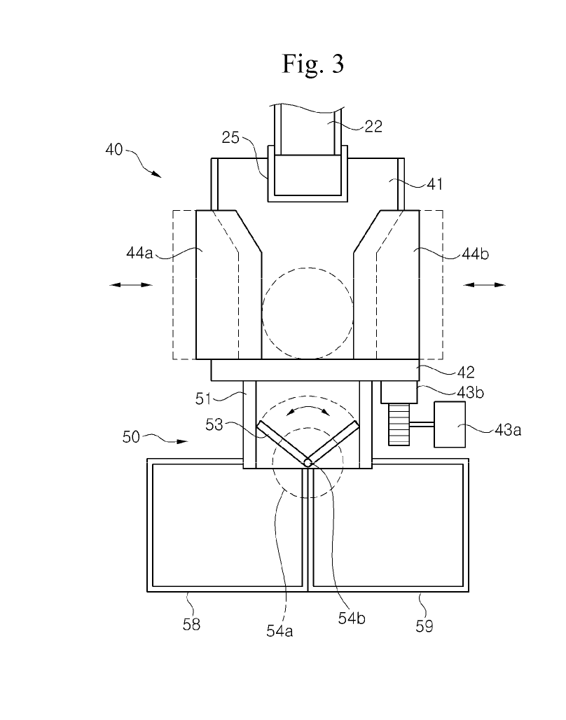

A medicine cutting device according to a first embodiment of the present invention is illustrated in FIGS. 1 to 8B.

As illustrated in FIG. 1, the medicine cutting device according to the first embodiment of the present invention includes a frame 10, a cutting unit 40, and a transferring unit 50. The cutting unit 40 is mounted on the frame 10 to hold and cut the medicine into half-cut-tablets. The transferring unit 50 transfers the half-cut-medicines to an accommodation container 58.

The medicine cutting device according to the first embodiment of the present invention further includes an aligning unit 20 and a supplying unit 30. The aligning unit 20 is mounted on the frame 10 to align the medicines in a row by moving and spacing the medicines from one another. The supplying unit 30 is disposed in an upstream side of the aligning unit 20 on the frame 10 and supplies the medicines to be cut to the aligning unit 20.

The aligning unit 20 includes a vibrator 21 for generating a vibration, and a plate 22 attached to the vibrator 21 and vibrated together with the vibrator 21. The vibrator 21 may be selected from any conventional configuration as long as it can vibrate the plate 22 in a linear direction, and thus, a detailed description thereof will be omitted herein.

The plate 22 is vibrated by the vibrator 21 to slightly move the medicines placed on the top surface thereof. The plate 22 includes a groove section 23 formed for moving the medicines in a row.

The groove section 23 includes one or more inclined surfaces. Therefore, the bottom surface of the groove section 23 forms one or more steps. While a medicine passes through the inclined surface, a moving speed of the medicine increases, causing the medicine to be further separated from a subsequent medicine. As such, the inclined surface formed in the groove section 23 increases the distance between the medicines during discharge, and therefore, the discharge of the medicines may be accurately controlled.

The groove section 23 may have a U- or V-shaped cross-section to allow the medicine to move along a center line of the groove section 23. Furthermore, when the plate 22 is formed with two or more inclined surfaces, the respective inclined surfaces may be designed to have the same or different inclination angles as occasion demands.

The plate 22, which is vibrated by the aligning unit 20, may be made of a metal material, a non-metal material, or a combination thereof. In particular, a coefficient of friction may be changed according to a constituent material of an upper surface of the plate 22 that comes into contact with the medicine, and the change in the coefficient of friction causes a change in the moving speed of the medicine. Therefore, it is desirable that a constituent material of the plate 22 be selected in consideration of a moving speed of the medicine conforming to a design demand.

In addition, the upper surface of the plate 22, especially the surface of the groove section 23, may be coated with at least one of a Teflon resin and a urethane resin, so as to prevent the medicines from coming out or bouncing off when moving on the plate 22 and prevent the moving medicines from being overlapped with one another. The movement of the medicines may be influenced by the constituent material of the upper surface of the plate 22. Therefore, the performance of the product may be improved when a flexible coating layer is formed on the upper surface of the plate 22.

Although the aligning unit, which aligns the medicines to be spaced apart in a row by vibration, has been exemplarily described above, mechanisms other than vibration may be used as long as they can align a plurality of medicines to be spaced apart in a row.

The supplying unit 30 may be provided with a cylindrical feeder that is mounted on the frame 10 to move the medicines along a spiral path by vibration. The medicines supplied to an accommodation unit 31 of the supplying unit 30 at once are moved to the outside of the accommodation unit 31 along a spiral movement path 32 extending from the bottom of the accommodation unit 31. Accordingly, the medicines moving in a row from the cylindrical feeder serving as the supplying unit 30 along the spiral movement path 32 may be transferred, that is, dropped, from the cylindrical feeder to the top of the plate 22 and then consecutively transferred on the plate 22.

The spiral movement path 32 may be formed with one or more crevice, which allows one of two medicines moving in parallel along the spiral movement path 32 to fall into and return back to the accommodation unit 31 while passing through the crevice. For this purpose, the crevice may be formed at an inner edge of the spiral movement path 32.

The medicine moved upward to a distal end of the plate 22 is supplied to the cutting unit 40. To detect the number of medicines supplied to the cutting unit 40, the aligning unit 20 may include a detection passage 25 mounted with a sensor. When it is detected in the detection passage 25 that two or more medicines are supplied to the cutting unit 40 at once, the medicines are collected without being cutting, as described later.

The sensor installed in the detection passage 25 to detect the number of medicines dropped from the plate 22 may be, for example, a photosensor including a light emitting element and a light receiving element.

On the other hand, one or more sensors (not shown) may be arranged along the plate 22 so as to detect a position of a medicine moving on the plate 22. For example, in the case in which the sensor is installed in a distal end of the supplying unit 30 of the plate 22, the detection may be performed immediately after the medicine is supplied from the supplying unit 30 to the top of the plate 22. In the case in which the sensor is installed in a distal end of the cutting unit 40 of the plate 22, the detection may be performed immediately before the medicine is supplied from the plate 22 to the cutting unit 40. In addition, sensors may be installed at other positions on the plate 22 to detect the moving state of the medicine.

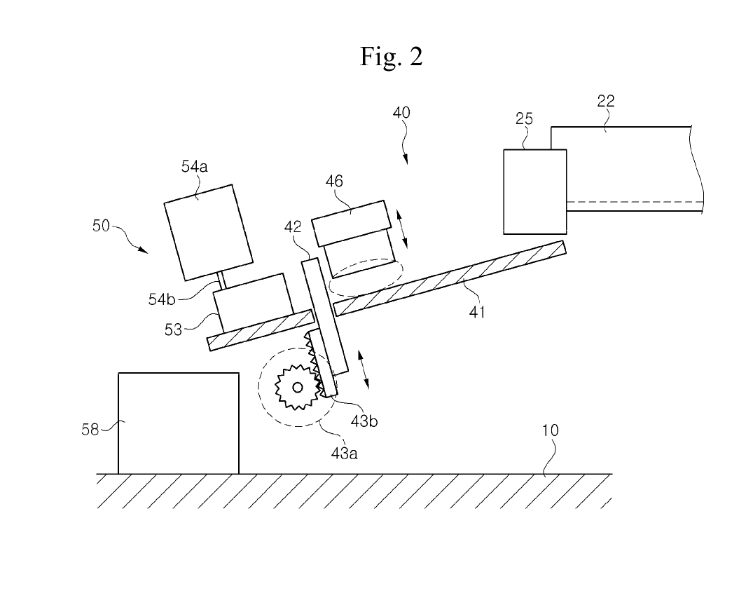

As illustrated in FIGS. 2 to 5B, the cutting unit 40 includes an inclined plate 41, a stopping plate 42, holding members 44a and 44b, and a cutter 46. The stopping plate 42 stops the medicine sliding down along the inclined plate 41. The holding members 44a and 44b hold the medicine stopped by the stopping plate 42 from left and right. The cutter 46 cuts the medicine held by the holding members 44a and 44b.

Like the plate 22 of the aligning unit 20, the upper surface of the inclined plate 41 may be coated with one or more of a Teflon resin and a urethane resin, so as to prevent the medicines from bouncing off after the medicine transferred from the aligning unit 20 collides against the inclined plate 41. Since a coating layer formed in the inclined plate of a region where the cutter 46 operates may be damaged, it is suitable that no coating layer be formed in the corresponding region.

The stopping plate 42 may be installed to be movable in a direction perpendicular to the inclined plate 41 by a motor 43a, a rack gear 43b, and the like. When the cutting operation of the cutter 46 is completed, the stopping plate 42 is moved downward so that half-cut-tablets are supplied to the transferring unit 50.

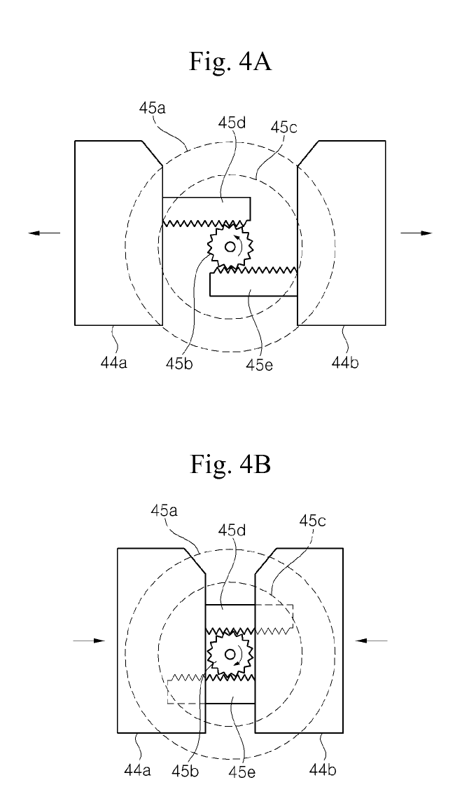

As illustrated in FIGS. 4A and 4B, the pair of left and right holding members 44a and 44b is configured to be movable in opposite directions, that is, closer to each other or farther from each other, on the inclined plate 41 by the same distance at the same time by rack gears 45d and 45e. A pinion 45b is engaged between the rack gears 45d and 45e attached to the pair of left and right holding members 44a and 44b. The pinion 45b receives torque from the motor 45a through a clutch 45c. Since the clutch 45c is disposed between the motor 45a and the pinion 45b, the medicine may be held at an appropriate pressure by the pair of left and right holding members 44a and 44b. Even though the motor 45a is continuously rotated while the holding members 44a and 44b comes into contact with the medicine to hold the medicine from left and right, torque transmitted from the motor to the holding members 44a and 44b is interrupted. Therefore, it is possible to prevent a problem that the medicine is damaged when excessive pressure is applied to the medicine by the holding members 44a and 44b. The clutch 45c may be provided with a slip clutch available in the markets. Since the slip clutch is well known, a detailed description thereof will be omitted herein.

Surfaces of the holding members 44a and 44b, which directly come into contact with the medicine, may be made of an elastic material or a shock-absorbing material so as to prevent the damage of the medicine.

The medicine cutting device according to embodiments of the present invention may include a distance sensor and a controller. The distance sensor detects a distance between the holding members 44a and 44b when the holding members 44a and 44b are operated to hold the medicine. The controller stores information on the detected distance and processes the stored information. The distance sensor may be selected from any configuration as long as it can measure the distance between the pair of holding members 44a and 44b, such as a photosensor including a light emitting element and a light receiving element.

In the process of consecutively cutting the same medicine, the distance between the holding members 44a and 44b is equal at each cutting operation in a normal case. Therefore, in the process of consecutively cutting the medicine, if a distance between the holding members 44a and 44b, which is detected by the distance sensor in an n-th operation, is different from a distance between the holding members 44a and 44b, which is detected by the distance sensor in a previous operation, that is, an (n-1)-th operation, the controller determines that there occurs an error such as different types of medicines, damage of a medicine, or an incorrect medicine stop position and posture. Therefore, the controller may operate the medicine cutting device to discharge the medicine toward a collection container 59, without performing the cutting operation.

In addition, according to embodiments of the present invention, the cutting speed of the cutter may be controlled by the controller according to the type of the medicine, that is, whether the medicine is soft or hard.

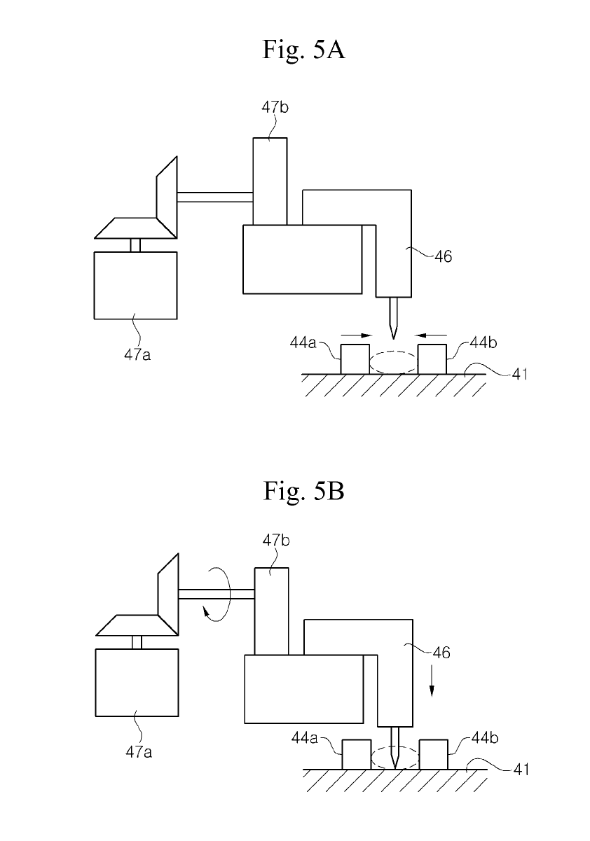

The cutter 46 moves in a direction perpendicular to the inclined plate 41, and maintains a predetermined spacing from the inclined plate 41 in a standby mode. However, if it is detected by the sensor (not shown) that the medicine is held by the holding members 44a and 44b, the cutter 46 moves toward the inclined plate 41 and cuts the held medicine. For this purpose, as illustrated in FIGS. 5A and 5B, the cutter 46 may be moved an appropriate distance by a cam member 47b which is driven by the motor 47a.

If half-cut-tablets made by the cutting operation of the cutting unit 40 and stopped by the stopping plate 42 are released from the stopped state, that is, if the stopping plate 42 is moved downward to open the passage, the half-cut-tablets are supplied toward the transferring unit 50. The transferring unit 50 includes a transfer passage 51 and a pivot member 53 which is pivotable around a pivot shaft 54b within the transfer passage 51 by a motor 54a. The transferring unit 50 may further include an accommodation container 58 configured to accommodate the half-cut-tablets, and a collection container 59 configured to accommodate the tablets that are not cut into halves.

When a single medicine is detected in the detection passage 25 of the aligning unit 20, the pivot member 53 is pivoted such that the medicine is transferred to the accommodation container 58. Accordingly, the half-cut-tablets stopped by the stopping plate 42 and then cut may be accommodated in the accommodation container 58 through the transfer passage 51 immediately after the stopped state of the tablets due to the stopping plate 42 is released.

On the other hand, when two or more medicines are detected in the detection passage 25 of the aligning unit 20, the pivot member 53 is pivoted such that the medicines are collected in the collection container 59. Accordingly, the two or more medicines stopped by the stopping plate 42 may be collected in the collection container 59 through the transfer passage 51 immediately after the stopped state of the medicines due to the stopping plate 42 is released.

When the medicine is cut into halves by the cutting unit 40, a medicine having an elongated shape, such as an elliptical or cylindrical shape, needs to be aligned such that an elongated side of the medicine comes into contact with the stopping plate 42. For this purpose, the medicine cutting device according to embodiments of the present invention may further include a transverse laying-down unit 60 for vibrating the medicine stopped upright by the stopping plate 42 in a width direction of the medicine cutting device, such that the upright medicine is laid down sideways.

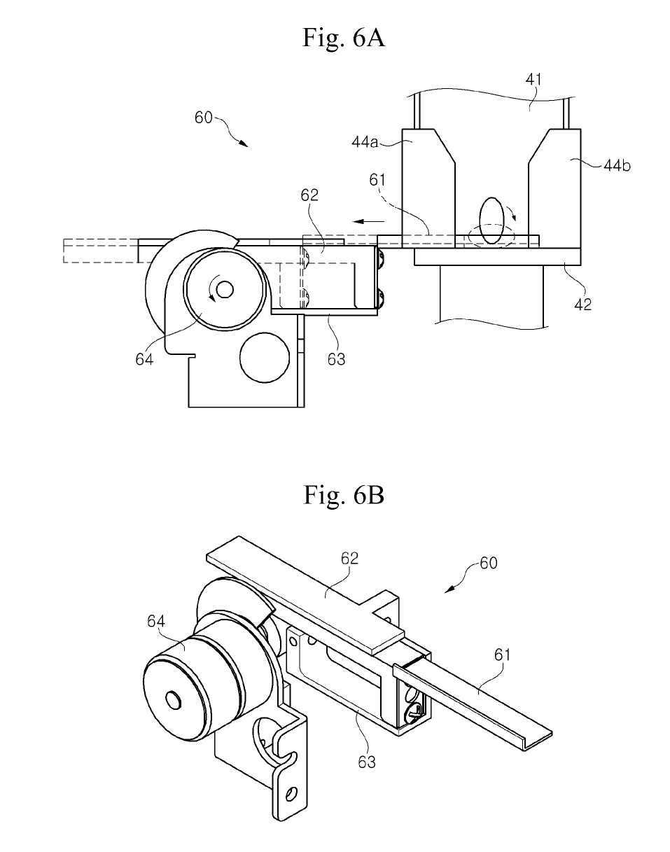

As illustrated in FIGS. 6A and 6B, the transverse laying-down unit 60 includes a transverse laying-down member 61 and a motor 64. The transverse laying-down member 61 slides in a transverse direction so as to apply an external force in a transverse direction with respect to the transferred and stopped medicine. The motor 64 provides torque for moving the transverse laying-down member 61.

The transverse laying-down member 61 may be configured to receive torque from the motor 64 through a movable member 62, a straight movement of which is guided by a guide member 63. The torque may be transmitted between the motor 64 and the movable member 62 by a torque transmission unit, such as a pinion and a rack gear (not shown).

The transverse laying-down member 61 of the transverse laying-down unit 60 is installed to slide in front of the stopping plate 42 of the cutting unit 40. Before the medicine is supplied to the inclined plate 41, the transverse laying-down member 61 is controlled to be on standby in front of the stopping plate 42. When the supplied medicine slides down along the inclined plate 41 and is stopped in contact with the transverse laying-down member 61, the transverse laying-down member 61 is controlled to move in a transverse direction. Due to the movement of the transverse laying-down member 61, an external force is applied to the medicine in a transverse direction, that is, a width direction of the medicine cutting device. Accordingly, the medicine stopped upright is laid down sideways on the stopping plate 42, and thus, the medicine can be easily cut.

When the cutting of the medicine by the cutter 46 is completed and the cut medicine is discharged toward the accommodation container 58 or the collection container 59 by the transferring unit 50, the transverse laying-down member 61 is controlled to return to the original position and be on standby in front of the stopping plate 42.

In addition, when the medicine is cut into halves by the cutting unit 40, a flat medicine may be stopped upright on the stopping plate 42. In this case, the medicine needs to be laid down sideways so as to facilitate the cutting operation. For this purpose, the medicine cutting device according to embodiments of the present invention may further include a longitudinal laying-down unit 70 configured to lay down the medicine, which is stopped upright by the stopping plate 42, sideways on the inclined plate 41.

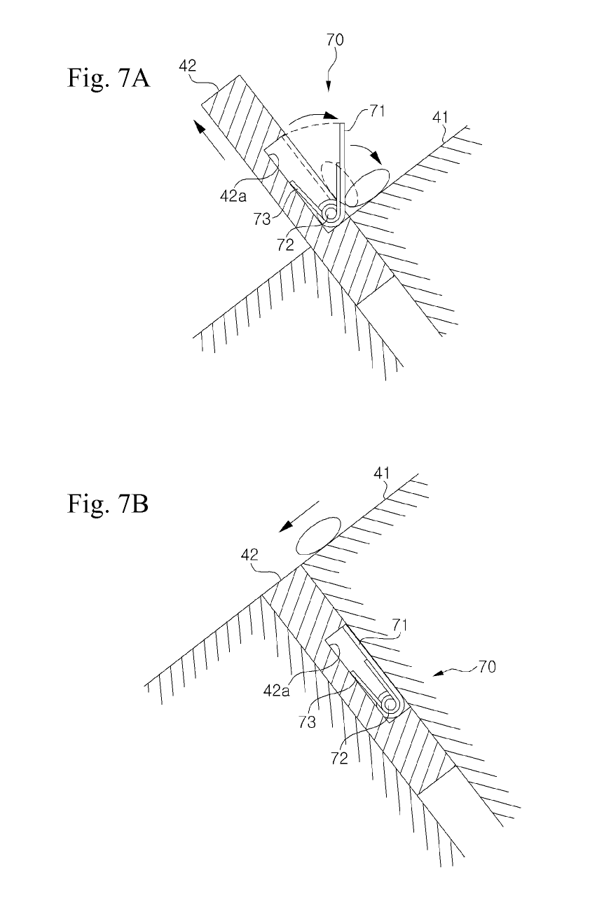

As illustrated in FIGS. 7A and 7B, the longitudinal laying-down unit 70 includes a longitudinal laying-down member 71 and an elastic member 73. The longitudinal laying-down member 71 is pivoted to apply an external force to the medicine stopped by the stopping plate 42, such that the medicine is laid down sideways on the inclined plate 41. The elastic member 73 applies pressure to pivot the longitudinal laying-down member 71.

The longitudinal laying-down unit 70 is installed in a concave section 42a formed inside the stopping plate 42. The longitudinal laying-down member 71 is pivotable around a shaft 72 disposed in the concave section 42a. The elastic member 73 may be a coil spring which is fit into the shaft 72.

As illustrated in FIG. 7A, when the stopping plate 42 is moved above the inclined plate 41, the longitudinal laying-down member 71 pivots around the shaft 72 by the pressure applied by the elastic member 73, and therefore, the medicine protruding from the concave section 42a of the stopping plate 42 and standing upright against the stopping plate 42 may be laid down sideways on the inclined plate 41.

As illustrated in FIG. 7B, when the stopping plate 42 is moved under the inclined plate 41, the medicine is transferred toward the transfer passage 51 of the transferring unit 50 and is supplied to the accommodation container 58 or the collection container 59. At this time, the longitudinal laying-down member 71 is pressurized by the wall surface of the inclined plate 41, so that the elastic member 73 is compressed and pivoted to return to the inside of the concave section 42a of the stopping plate 42.

In the front of the longitudinal laying-down member 71 configured and operated as described above, that is, between the longitudinal laying-down member 71 and the medicine, the transverse laying-down member 61 of the transverse laying-down unit 60 described above with reference to FIGS. 6A and 6B may be positioned to be slidable in a transverse direction of the medicine cutting device.

In addition, after the medicine is cut into halves by the cutting unit 40, the half-cut-tablets may be stopped. Therefore, there is a need for surely transferring the cut medicine to the transferring unit 50. For this purpose, the medicine cutting device according to embodiments of the present invention may further include a forcible transferring unit 80 configured to forcibly transfer the medicine cut by the cutting unit 40 to the transferring unit 50.

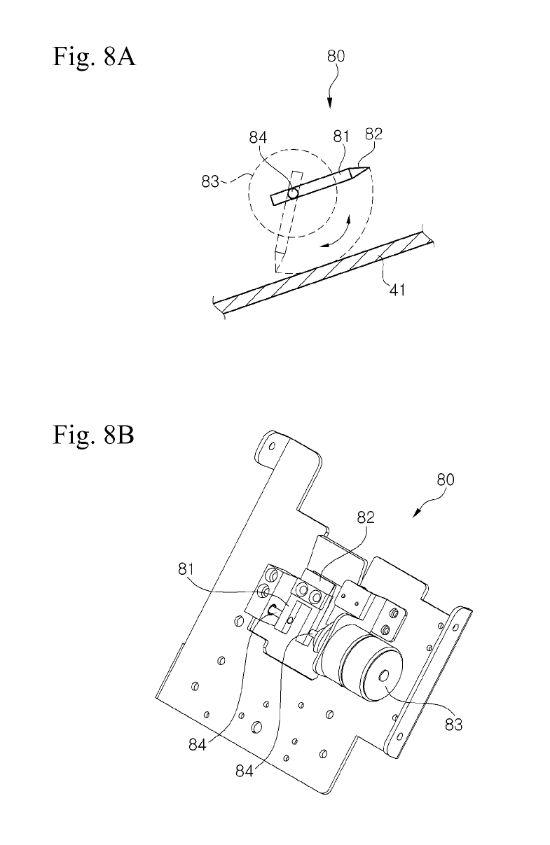

As illustrated in FIG. 8A and 8B, the forcible transferring unit 80 includes a forcible transferring member 81, a flexible section 82, and a motor 83. The forcible transferring member 81 performs a reciprocating pivoting motion, like a pendulum, on the inclined plate 41 of the cutting unit. The flexible section 82 is attached to a distal end of the forcible transferring member 81 to sweep across the upper surface of the inclined plate 41. The motor 83 drives the forcible transferring member 81 such that the forcible transferring member 81 pivots around a rotational shaft 84.

The forcible transferring member 81 may have a substantial U-shape with a central portion opened, such that the movement of the cutter 46 included in the cutting unit is not obstructed. Accordingly, two rotational shafts 84 are installed on both sides of the forcible transferring member 81, and the motor 83 is installed to connect to only one of the two rotational shafts 84. The rotational shaft 84 to which the motor 83 is not connected may be supported to be freely rotatable by a bearing.

The flexible section 82 may be made of a flexible material, for example, a silicon resin, so as not to damage the inclined plate 41 when coming into contact with the inclined plate 41. The flexible section 82 may be detachably installed in the forcible transferring member 81 so as to be replaced when worn out.

According to embodiments of the present invention, the forcible transferring unit 80 may prevent the cut medicine from being stopped on the inclined plate 41, and may also clean medicine fragments generated during the cutting of the medicine.

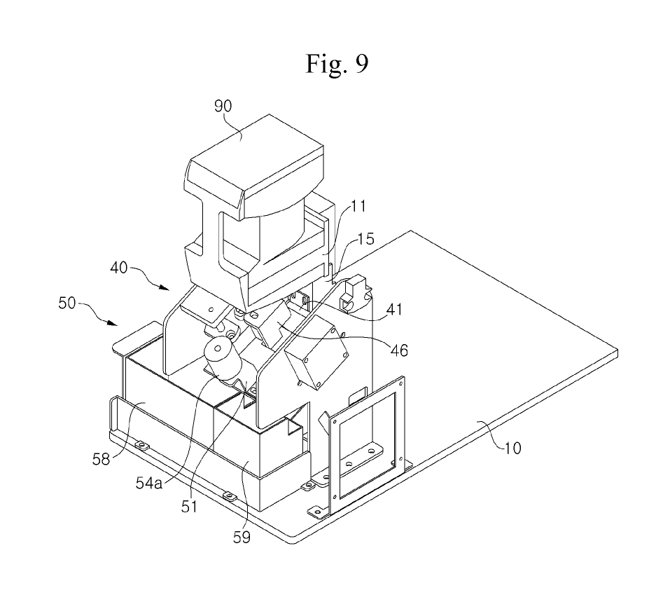

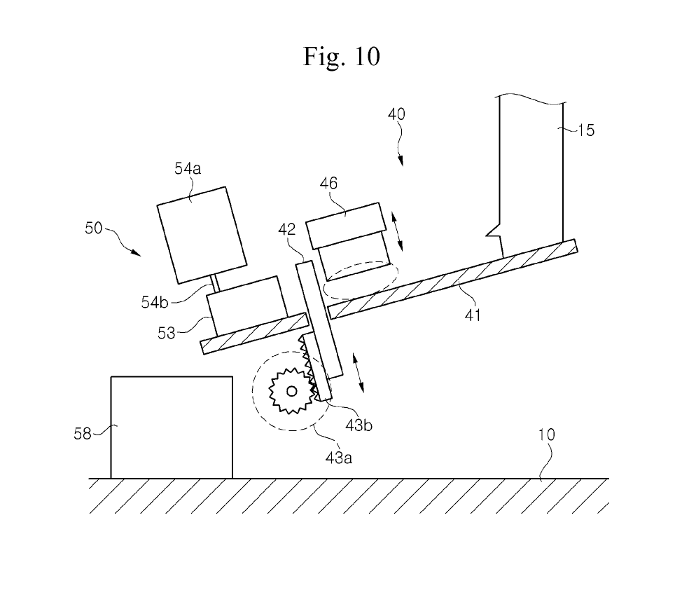

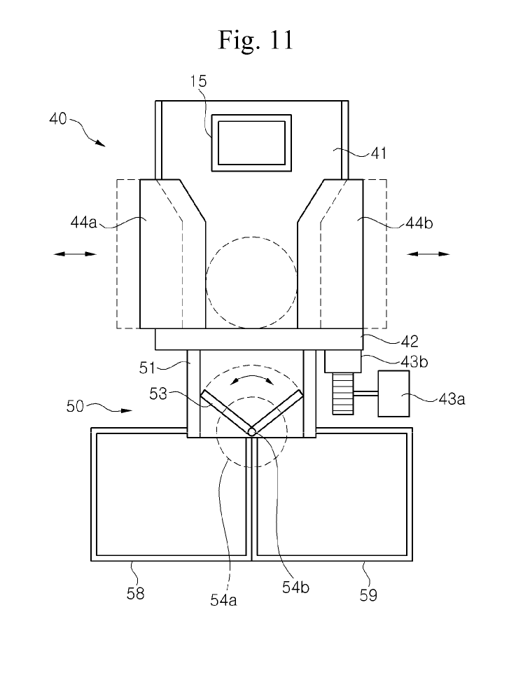

Hereinafter, a medicine cutting device according to a second embodiment of the present invention will be described in detail with reference to FIGS. 9 to 11.

As illustrated in FIG. 9, as with the first embodiment, the medicine cutting device according to the second embodiment of the present invention includes a frame 10, a cutting unit 40, and a transferring unit 50. The cutting unit 40 is mounted on the frame 10 to hold and cut the medicine into half tablets. The transferring unit 50 transfers the half-cut-tablets to an accommodation container 58.

However, the medicine cutting device according to the second embodiment is different from the first embodiment in that cassettes 90 detachably mounted on the frame 10 to discharge the accommodated medicines one pill at a time are used so as to perform the functions of the aligning unit 20 and the supplying unit 30 of the first embodiment. Hereinafter, the same reference numerals are assigned to the same elements as those of the first embodiment, and a detailed description thereof will be omitted herein. The following description will focus on the differences between the first embodiment and the second embodiment.

The cassettes 90 may be detachably mounted on a cassette support 11 such that the cassettes 90 are disposed above the cutting unit 40. The cassettes 90 may be provided with any conventional configuration. That is, although not shown, the cassette 90 includes a cassette body, a distribution block, and a partition member. The cassette accommodates the medicines such as tablets or capsules having various sizes and shapes. The distribution block is rotatably provided in the cassette body to separate and discharge the medicines. The partition member is installed in the cassette body to discharge the medicines in a predetermined amount when the medicines are discharged by the distribution block. The cassette support 11 supporting the cassette body has a motor embedded therein to rotate the distribution block.

The distribution block includes a plurality of discharge grooves in an outer peripheral surface thereof, so that the medicines accommodated in the cassette body are discharged from the cassette body along the discharge grooves. In this case, the partition member is installed to close the discharge grooves so that only a predetermined amount of the medicine is discharged.

The cassette 90 is detachably installed on the cassette support 11. Therefore, when all the medicines accommodated in the cassettes 90 are discharged in the process of cutting the medicines, the cassettes may be easily replaced with new cassettes accommodating medicines. In addition, replacement with different types of medicines may be easily performed by preparing for cassettes accommodating various types of medicines and mounting the cassette 90 accommodating a relevant medicine on the cassette support 11 as occasion demands.

The medicine discharged from the cassette 90 one pill at a time is supplied to the cutting unit 40. To detect the number of medicines supplied to the cutting unit 40, a detection passage 15 mounted with a sensor may be installed between the cassette 90 and the cutting unit 40. When it is detected in the detection passage 15 that two or more medicines are supplied to the cutting unit 40 at once, the medicines are collected without being cutting, as described later.

The sensor installed in the detection passage 15 to detect the number of medicines dropped from the cassette 90 may be, for example, a photosensor including a light emitting element and a light receiving element.

As described above, in the second embodiment, the supplying unit may be provided with the cassettes 90 which may accommodate medicines and discharge the accommodated medicines one pill at a time.

Meanwhile, although the cylindrical feeder is provided as an example of the supplying unit in the first embodiment and the cassette is provided as an example of the supplying unit in the second embodiment, it is apparent that other units, except for the cylindrical feeder or the cassette, may be used as the supplying unit.

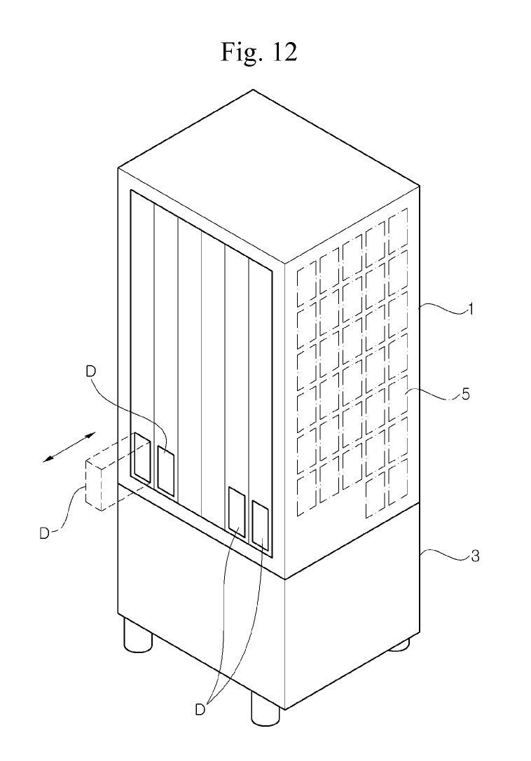

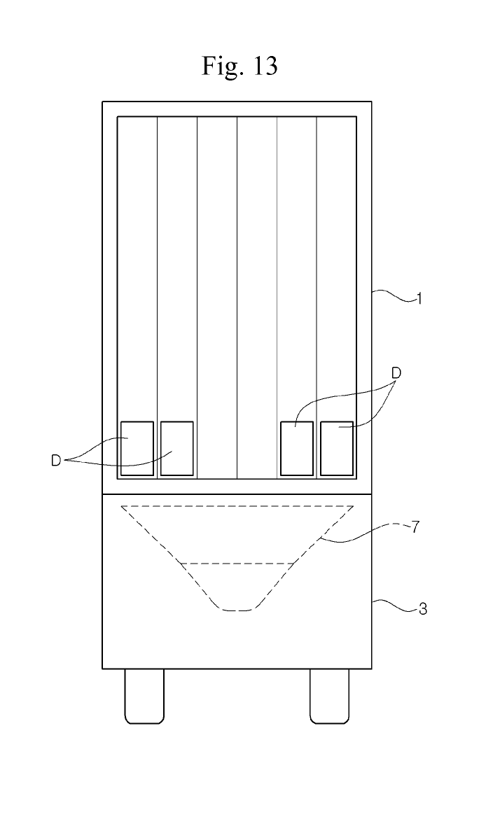

Hereinafter, an automatic medicine packing machine mounted with the medicine cutting device D according to embodiments of the present invention will be described in detail with reference to FIGS. 12 and 13.

The automatic medicine packing machine may include a plurality of cassettes 5, a hopper 7, a printing unit, and a packing unit. The plurality of cassettes 5 are disposed in an upper portion 1 of a main body and accommodate medicines such as tablets or capsules having various sizes and shapes. The hopper 7 is disposed in a lower portion 3 of the main body and collects the medicines discharged and dropped from the cassettes 5. The printing unit prints a variety of information on the surface of a packing paper for packing the medicine. The packing unit packs the medicines with the packing paper when the medicines are collected in the hopper. Various types of automatic medicine packing machines, except for the automatic medicine packing machine illustrated in FIGS. 12 and 13, may also be used herein. Embodiments of the present invention are not limited to the types or shapes of the automatic medicine packing machines, the arrangement of the cassettes, or the number of the cassettes.

As illustrated in FIGS. 12 and 13, the medicine cutting device D according to one or more embodiments of the present invention may be arranged together with the cassettes 5 on the upper portion 1 of the main body of the automatic medicine packing machine.

The cassettes 5 mounted on the automatic medicine packing machine may have the same configuration as the cassettes 90 used in the second embodiment.

When the medicine cutting device D is installed inside the automatic medicine packing machine, the medicine cutting device D may be arranged together with the plurality of cassettes 5 accommodating medicines such as tablets or capsules having various sizes and shapes on the main body, in particular, the upper portion 1 of the main body. When the medicine cutting device D is arranged in the upper portion 1 of the main body, the medicine discharged from the medicine cutting device D and the medicine discharged from the cassettes 5 may pass through the same hopper 7 and then be packed.

The hopper 7 is installed in the lower portion 3 of the main body of the automatic medicine packing machine. In addition to the hopper 7 collecting the dropped medicines, the printing unit (not shown) for printing a variety of information on the surface of the packing paper for packing the medicine and the packing unit (not shown) for packing the medicine collected in the hopper with the packing paper may be installed in the lower portion 3 of the main body.

As such, when the medicine cutting device D and the cassettes 5 are arranged together in the upper portion 1 of the main body, the hopper 7 installed in the lower portion 3 of the main body so as to collect the medicines discharged from the cassettes 5 may be used to collect and pack the medicines discharged from the medicine cutting device D. Therefore, it is unnecessary to install a separate hopper for the medicine cutting device D only. In addition, when the medicine cutting device D is installed in the lower portion 3 of the main body, the configuration of the hopper 7 may be modified or a separate hopper may be installed, so that the medicines discharged from the medicine cutting device D are transferred to the packing unit.

The medicine cutting device D may be installed to be drawable for the purpose of supplement of medicines, cleaning, maintenance, and the like. For example, the medicine cutting device D may be installed to be drawable from the upper portion 1 of the main body in a longitudinal direction of the medicine cutting device D.

In FIGS. 12 and 13, although the medicine cutting device D is shown as being arranged in the lowermost portion of the cassettes 5, the medicine cutting device D may also be arranged in the middle of the cassettes 5 or in the uppermost portion of the cassettes 5.

Furthermore, one or more medicine cutting devices D may be installed inside the automatic medicine packing machine. Although four medicine cutting devices D drawable in the longitudinal direction (that is, the longitudinal direction of the medicine cutting devices D) are shown in FIGS. 12 and 13, the number of the medicine cutting devices D may be changed as occasion demands.

When the medicine cutting device D is installed inside the automatic medicine packing machine, the medicine cutting device D may be configured to supply as many medicines as needed toward the packing unit according to the packing period of packing the medicines accommodated in the cassettes of the automatic medicine packing machine and discharged therefrom.

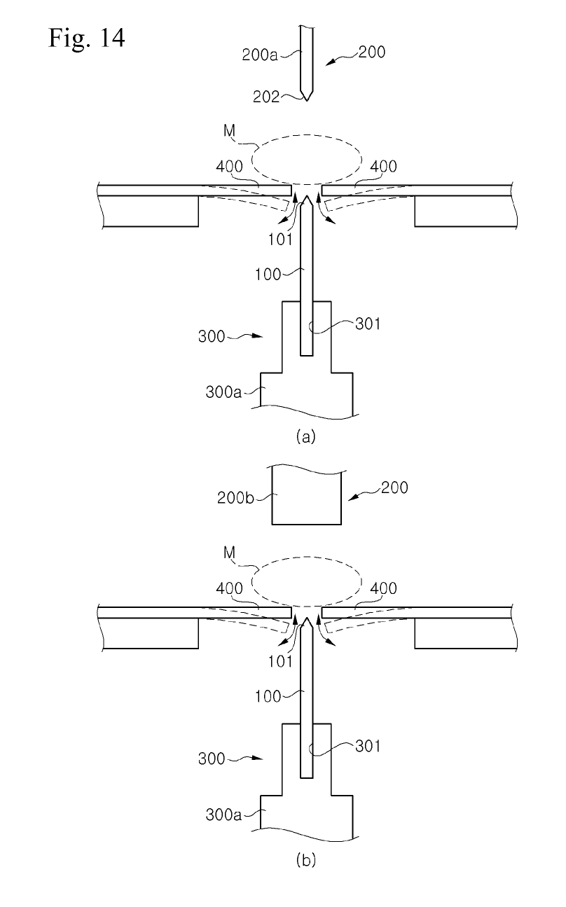

FIG. 14 is a conceptual diagram illustrating an overall configuration of a medicine cutting device according to a third embodiment of the present invention, and

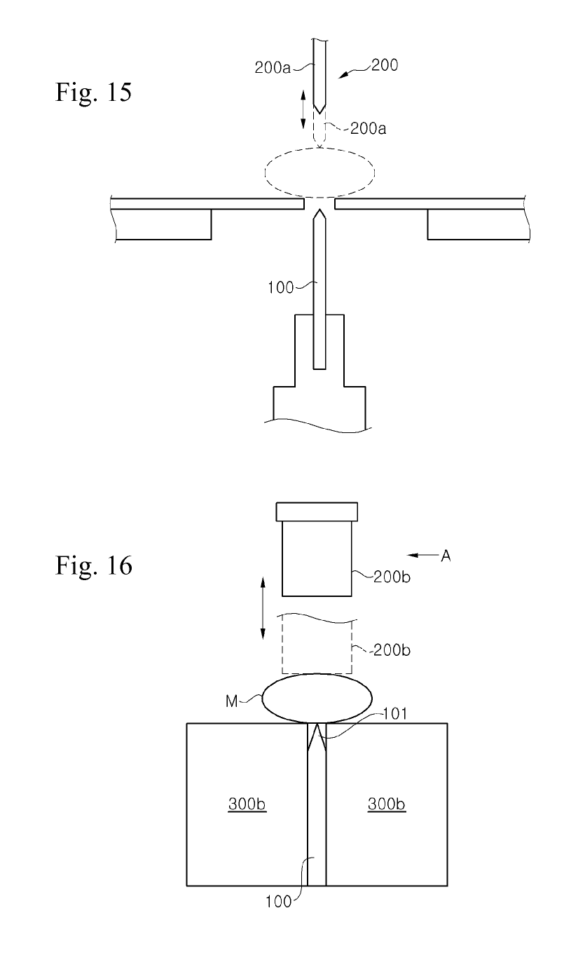

FIG. 15 is a conceptual diagram illustrating a state in which the medicine cutting device according to the third embodiment of the present invention cuts a medicine.

As illustrated in FIGS. 14 and 15, a first member 100 and a second member 200 are configured to cut a medicine M in cooperation with each other.

The first member 100 is a first cutter 100 in which a cutter blade 101 of an upper end thereof is disposed in a direction parallel to a direction in which the medicine M is supplied.

For reference, reference numeral 100 is used for both the first member and the first cutter for convenience.

The second member 200 faces the first cutter blade 101. When the medicine M is disposed between the second member 200 and the first cutter blade 101, the second member 200 cuts the medicine M in cooperation with the first member 100.

A guide member 300 is disposed on both sides of the first member 100 and supports the first member 100.

As illustrated in FIG. 15, the second member 200 can cut the medicine M while performing an elevating reciprocating motion with respect to the fixed first member 100. Although not specially illustrated, the medicine M can also be cut while the first member 100 performs an elevating reciprocating motion with respect to the fixed second member 200, or the first member 100 and the second member 200 perform an elevating reciprocating motion in a mutually proximal or distal direction.

As illustrated in FIG. 14A, in the second member 200, a second cutter blade 202 of a lower end thereof is disposed in a direction parallel to a direction in which the medicine M is supplied. Therefore, the second cutter 200a facing the first cutter blade 201 can be applied.

In addition, as illustrated in FIG. 14B, the second member 200 faces the first cutter blade 101 and moves upward from the upper portion of the first member 100. When the supplied medicine M is disposed at the first cutter blade 101, a pressing block 200b pressing the medicine M can be applied.

The pressing block 200b is configured to cut the medicine M into halves while applying a pressure in close contact with the medicine M from the upper side of the medicine M. In order to prevent the medicine M from being broken into various irregular shapes, it is preferable that the pressing block 200b is made of an elastic material, such as synthetic rubber or synthetic resin, which closely contacts the medicine M while allowing a shape deformation according to an outer-surface shape of the medicine M.

In addition, the medicine cutting device according to the third embodiment of the present invention may further include spring plates 400 that are disposed on both sides of the first cutter blade 101, are perpendicular to the first member 100, provide an area where the medicine M is disposed, and allow a shape deformation.

The spring plates 400 are a type of leaf spring, and are a technical means for receiving the pressing force of the second member 200 and assisting smooth cutting while supporting the medicine M to be cut.

In this case, it is preferable that the top surfaces of the spring plates 400 are disposed at positions equal to or higher than the positions of the first cutter blade 101 so as not to disrupting the cutting of the medicine M.

In addition, the guide member 300 is a fixing jig 300a with a fixing slit 301 closely supporting and fixing the lower portion of the first member 100. The fixing jig 300a can move upward the first member 100 while allowing elevation such that the medicine M is cut in cooperation with the second member 200.

On the other hand, as illustrated in FIG. 16, aspects of the present invention can include an embodiment configured such that guide blocks 300b being the guide member 300 elevates while interworking with the pressing block 200b being the second member 200.

That is, according to an embodiment of the present invention, when the pressing block 200b moves downward to the medicine M held on the top surfaces of the guide blocks 300b movable upward on both sides of the first cutter blade 101 with reference to the first member 100, and applies a pressure to the medicine M, the medicine M is cut by the first cutter blade 101 of the first member 100.

The pressing block 200b faces the first cutter blade 101 and moves upward from the upper side of the first member 100. When the supplied medicine M is placed at the first cutter blade 101, the pressing block 200b moves downward and applies a pressure to the medicine M while contacting the top surface of the medicine M, and continuously applies a pressure such that the pressed medicine M is cut.

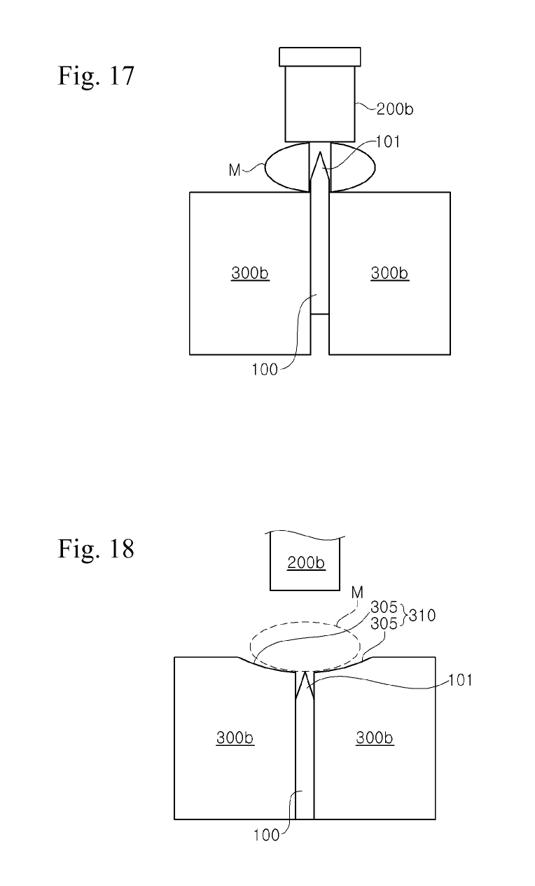

As illustrated, the guide blocks 300b are disposed in close contact with both sides of the first member 100, and move upward while interworking with the pressing block 200b. When the pressure by the pressing block 200b is applied to the medicine M, the guide blocks 300b moves downward while interworking with the pressing block 200b, until the medicine M is cut into halves, as illustrated in FIG. 17.

It is preferable that the medicine M is held on the first cutter blade 101 and the top surfaces of the guide blocks 300b such that the medicine M receives the pressure by the pressing block 200b.

Therefore, when the medicine M is completely cut, the pressing block 200b and the guide blocks 300b are returned to the original positions in order to cut a next medicine M.

It is preferable that the end edge of the first cutter blade 101 and the top surfaces of the guide blocks 300b are disposed on the same plane so as to hold and cut the medicine M at the exact position.

In addition, as illustrated in FIG. 18, semispherical grooves 305 recessed with reference to the first cutter blade 101 of the first member 100 on the top surfaces of the guide blocks 300b form a guide groove 310 as a whole. Therefore, when the medicine M is placed at the guide groove 310, the medicine M can be cut into halves at the more exact position.

In order to hold and cut the medicine M at the exact position, it is preferable that the bottom surface of the guide groove 310 is disposed on the same plane as the end edge of the first cutter blade 101.

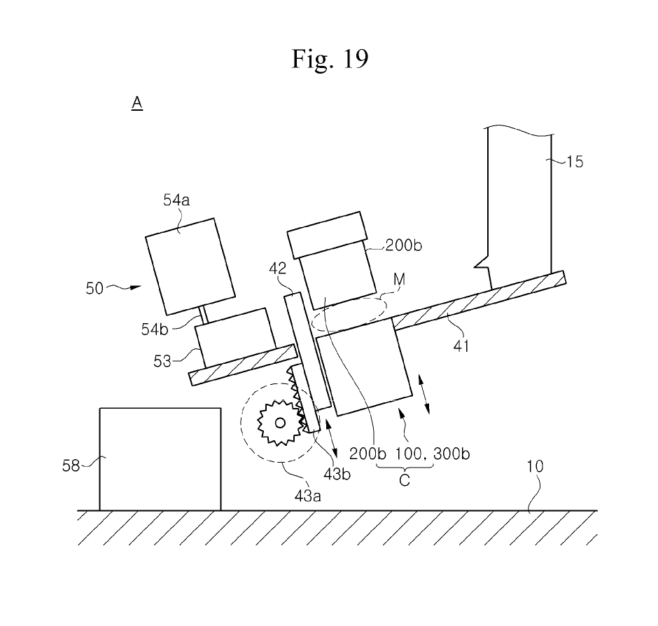

It is apparent that the medicine cutting devices having the above-described configuration according to various embodiments can also be applied as a partial configuration of an automatic medicine packing machine as illustrated in FIG. 19.

That is, the medicine cutting device according to an embodiment of the present invention is mounted on a frame 10, and includes a transferring unit 50 for transferring half-cut-medicines to an accommodation container 58. A detection passage 15 is installed to collect the medicine M, without cutting, when it is detected that two or more medicines M are supplied at a time from the cassette (not illustrated) to the medicine cutting device C.

A sensor installed in the detection passage 15 to detect the number of medicines dropped from the cassette may be, for example, a photosensor including a light emitting element and a light receiving element.

As described above, the medicine cutting device C includes the pressing block 200b in an upper portion and the first member 100 and the guide blocks 300b in a lower portion. In FIG. 19, the first member 100 and the guide blocks 300b are disposed on the same line in terms of viewpoint. Therefore, for convenience, reference numerals 100 and 300b are used together to refer to the first member and the guide blocks as the elements of the medicine cutting device C disposed in the lower portion.

An inclined plate 41 is disposed to be inclined along a direction in which the medicine M is supplied, with reference to the first member 100 and the guide blocks 300b of the medicine cutting device C.

A stopping plate 42 for stopping the medicine M sliding down along the inclined plate 41 is installed in front of the first member 100 and the guide blocks 300b. The stopping plate 42 moves upward to be enterable from the inclined plate 41.

The stopping plate 42 may be installed to be movable in a direction perpendicular to the inclined plate 41 by a motor 43a, a rack gear 43b, and the like.

When the pressing block 200b moves downward in a direction perpendicular to the inclined plate 41 and the medicine M is cut while contacting the fixed first member 100, the guide blocks 300b also move downward in a direction perpendicular to the inclined plate 41, while interworking with the pressing block 200b, and assists the cutting of the medicine M.

When the cutting of the medicine M is completed, the stopping plate 42 moves downward and supplies the half-cut-medicines M to the transferring unit 50.

The transferring unit 50 includes a pivot member 53 which is pivotable around the pivot shaft 54b by the motor 54a.

When one medicine M is detected in the detection passage 15, the pivot member 53 pivots to transfer the medicine M to the accommodation container 58.

Therefore, after the half-cut-medicine M is stopped by the stopping plate 42, the medicine M can be accommodated in the accommodation container 58 through the inclined plate 41 immediately when the stopped state is released by the stopping plate 42.

As described above, aspects of the present invention provide a medicine cutting device capable of guiding medicine to an exact position and cutting the medicine M into exact halves.

As described above, embodiments of the present invention may provide a medicine cutting device capable of cutting and discharging medicines while automatically moving one pill at a time, and an automatic medicine packing machine with the same.

The medicine cutting device according to the embodiments of the present invention has been described above with reference to the accompanying drawings, but the present invention is not limited to the above-described embodiments and the accompanying drawings. It will be apparent to those skilled in the art that various modifications and changes can be made thereto within the spirit and scope of the present invention. Therefore, the appended claims are not limited by the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

What is claimed is:

1. A medicine cutting device for cutting and discharging medicines while moving one pill at a time, comprising:
a first member disposed in parallel to a direction in which a medicine is supplied; and
a second member facing the first member, wherein the medicine is disposed between the first member and the second member,
wherein the medicine is cut while the second member reciprocates with respect to the fixed first member, or the first member reciprocates with respect to the fixed second member, or the first member and the second member simultaneously reciprocate in a mutually proximal or distal direction.

2. The medicine cutting device according to claim 1, wherein the first member is a first cutter in which a first cutter blade of an upper end thereof is disposed in parallel to a direction in which the medicine is supplied, and faces the second member.

3. The medicine cutting device according to claim 1, wherein the second member is a second cutter in which a second cutter blade of a lower end thereof is disposed in parallel to a direction in which the medicine is supplied, and faces the first member, or is a pressing block that faces the first member, moves upward from an upper portion of the first member, and applies a pressure to the medicine when the medicine is disposed between the first member and the second member.

4. The medicine cutting device according to claim 1, further comprising:
spring plates that are disposed on both sides of the first member, are perpendicular to the first member, provide an area where the medicine is disposed, and allow a shape deformation,
wherein top surfaces of the spring plates are higher than or equal to top end of the first member.

5. The medicine cutting device according to claim 1, further comprising a guide member for supporting both sides of the first member,
wherein the guide member is a fixing jig with a fixing slit for closely supporting and fixing a lower portion of the first member.

6. The medicine cutting device according to claim 1, further comprising a guide member for supporting both sides of the first member,
wherein the guide member is a guide block that is disposed in close contact with both surfaces of the first member, moves upward while interworking with the second member, and, when a pressure by the second member is applied to the medicine, moves downward while interworking with the second member, until the medicine is cut into halves, and
the medicine is held on an upper end of the first member and a top surface of the guide block.

7. The medicine cutting device according to claim 6, wherein an end edge of the first cutter blade and a top surface of the guide block are disposed on the same plane.

8. The medicine cutting device according to claim 7, further comprising a guide groove recessed on both sides with reference to an upper portion of the first member on the top surface of the guide block.

9. The medicine cutting device according to claim 8, wherein a bottom surface of the guide groove is disposed on the same plane as the top surface of the first member.

10. The medicine cutting device according to claim 1, wherein one of the first member and the second member is an inclined plate installed in an inclined manner, and
the medicine cutting device further comprises a stopping plate for stopping the medicine which is moving on the inclined plate.

11. The medicine cutting device according to claim 10, further comprising holding members for holding the medicine, which is stopped by the stopping plate, from left and right,
wherein the holding members, which are a pair of left and right holding members, are configured to be movable in opposite directions to each other on the inclined plate, and
surfaces of the holding members, which directly come into contact with the medicine, are made of an elastic material so as to prevent the medicine from being damaged.

12. The medicine cutting device according to claim 11, wherein the holding member is moved left and right by a torque transmission unit comprising a rack gear and a pinion driven by a motor, and the torque transmission unit further comprises a clutch disposed between the motor and the pinion.

13. The medicine cutting device according to claim 11, further comprising a distance sensor for measuring a distance between the holding members when holding the medicine from left and right.

14. The medicine cutting device according to claim 13, further comprising a controller for discharging the medicine, without cutting the medicine, when a distance between the holding members, which is detected by the distance sensor in an n-th cutting operation, is different from a distance between the holding members, which is detected by the distance sensor in an (n-1)-th cutting operation in a consecutively cutting process.

15. The medicine cutting device according to claim 10, further comprising a transferring unit for transferring half-cut-medicines, which are made by cutting the medicine into halves, toward an accommodation container,
wherein the transferring unit comprises:
a transfer passage;
a pivot member pivotally installed inside the transfer passage;
the accommodation container for accommodating the half-cut-medicines; and
a collection container for accommodating medicines that are not cut into halves.

16. The medicine cutting device according to claim 10, further comprising an aligning unit mounted on the frame to align the moving medicines in a row such that the medicines are spaced apart from one another.

17. The medicine cutting device according to claim 16, wherein the aligning unit comprises:
a vibrator for generating vibration;
a plate attached to the vibrator to vibrate together with the vibrator;
a groove section formed in the plate so as to move the medicines in a row; and
a detection passage mounted with a sensor for detecting the number of medicines.

18. The medicine cutting device according to claim 10, further comprising a supplying unit disposed in an upstream side of the cutter to supply a medicine to be cut to the cutter,
wherein the supplying unit is any one selected from a cylindrical feeder which moves medicines along a spiral path by vibration, and a cassette which is detachably mounted to discharge medicines accommodated therein one pill at a time.

19. The medicine cutting device according to claim 10, further comprising a laying-down unit for laying a medicine that is stopped on the stopping plate in an upright state.

20. The medicine cutting device according to claim 10, further comprising a forcible transferring unit for forcibly transferring the cut medicines, such that the cut medicines are transferred along the inclined plate,
wherein the forcible transferring unit comprises:
a forcible transferring member installed to perform a reciprocating pivoting motion on the inclined plate;
a flexible section attached to a distal end of the forcible transferring member; and
a motor for pivoting the forcible transferring member around a rotational shaft.
